(19) United States
(12) Patent Application Publication
(10) Pub. No.: US 2025/0262563 A1
(43) Pub. Date: Aug. 21, 2025

(54) Wastewater Storage Bucket Capable of Accelerately Recycling Waste Liquids

(71) Applicant: Feng-Yu Liu, Taichung City (TW)

(72) Inventor: Feng-Yu Liu, Taichung City (TW)

(21) Appl. No.: 18/582,881

(22) Filed: Feb. 21, 2024

(51) Int. Cl. B01D 1/20; B01D 1/22; B01D 5/00

(52) U.S. Cl. CPC B01D 1/20; B01D 1/225; B01D 5/0027

(57) ABSTRACT

A wastewater storage bucket contains a body. The body including: an outlet, an inlet, and a motor configured to drive a stirrer to rotate. The stirrer is vertically inserted into a bottom of an inner wall of the body and is configured to rotatably stir the waste liquids evenly. The body also includes a circular tube fixed on a top of the inner wall thereof, multiple spray heads defined on the circular tube and configured to molecularize the waste liquids, multiple heaters arranged on the outer wall of the body away from the motor and configured to heat the water liquids in the body, and a discharge orifice defined on a center of a bottom of the inner wall of the body and configured to discharge the waste liquids.

### TECHNICAL FIELD

The present disclosure relates to a wastewater storage bucket which is capable of accelerately recycling waste liquids by using multiple spray heads to spray mists to condense the steams of water of the waste liquids into the liquids, thus recycling the liquids purely and accelerately.

### BACKGROUND

Taiwan is a major semiconductor manufacturing country and contributes considerable output value every year, but it also produces a large amount of waste. Wastewater produced by IC manufacturing plants, and most of wastewater are discharged from cleaning wafers, removing photoresist and etching. In the era of circular economy, how to convert waste into raw materials is something that both industry and government should pay attention to.

Conventionally, the traditional waste liquid recovery device mainly allows the waste water to reach a low-temperature boiling point between 30° C. and 60° C. in a vacuum distiller, and the water vapor condenses into water through the condenser. However, the traditional distiller cannot convert the large molecules of the recovered water into small molecules, resulting in poor purity, and the flow rate cannot be increased.

The present invention has arisen to mitigate and/or obviate the afore-described disadvantages.

### SUMMARY

A primary aspect of the present invention is to provide a wastewater storage bucket which is capable of accelerately recycling waste liquids by using multiple spray heads to spray mists to condense the steams of water of the waste liquids into the liquids, thus recycling the liquids purely and accelerately.

To obtain above-mentioned aspect, a wastewater storage bucket provided by the present invention contains a body, and the body includes:
an outlet defined on a top of an outer wall of the body, an inlet formed on the top of the outer wall of the body opposite to the outlet, and a motor fixed on a center of the top of the outer wall of the body and configured to drive a stirrer to rotate. The stirrer is vertically inserted into a bottom of an inner wall of the body and is configured to rotatably stir the waste liquids evenly;
The body also includes a circular tube fixed on a top of the inner wall thereof, multiple spray heads defined on the circular tube and configured to molecularize the waste liquids, multiple heaters arranged on the outer wall of the body away from the motor and configured to heat the water liquids in the body, and a discharge orifice defined on a center of a bottom of the inner wall of the body and configured to discharge the waste liquids.

Other objects and features will be in part apparent and in part pointed out hereinafter.

### BRIEF DESCRIPTION OF THE DRAWINGS

FIG. 1 is a cross sectional view showing the assembly of a wastewater storage bucket capable of accelerately recycling waste liquids according to a preferred embodiment of the present invention.

FIG. 2 is a cross sectional view taken along the line B-B of FIG. 1.

FIG. 3 is a cross sectional view showing the operation of the wastewater storage bucket capable of accelerately recycling waste liquids according to the preferred embodiment of the present invention.

### DETAILED DESCRIPTION

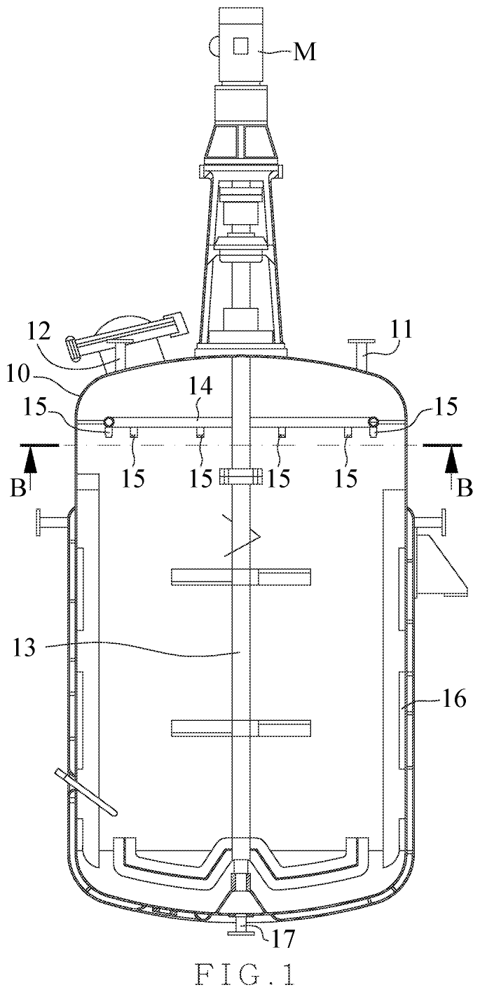

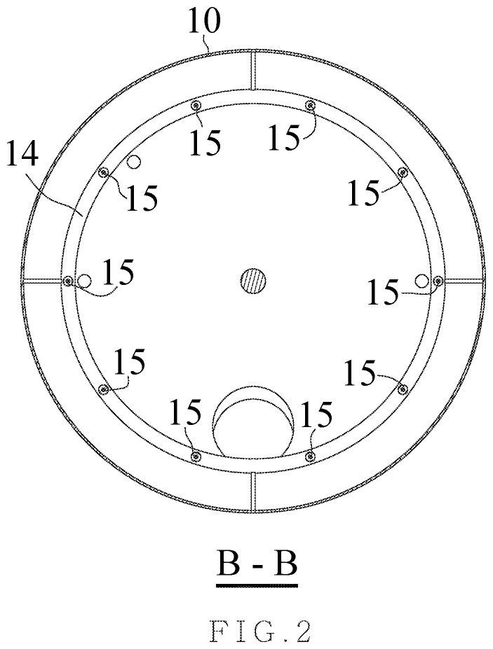

FIG. 1 is a cross sectional view showing the assembly of a wastewater storage bucket capable of accelerately recycling waste liquids according to a preferred embodiment of the present invention. FIG. 2 is a cross sectional view taken along the line B-B of FIG. 1. The wastewater storage bucket comprises a body 10, and the body 10 includes an outlet 11 defined on a top of an outer wall thereof, an inlet 12 formed on the top of the outer wall of the body 10 opposite to the outlet 11, a motor M fixed on a center of the top of the outer wall of the body 10 and configured to drive a stirrer 13 to rotate, wherein the stirrer 13 is vertically inserted into a bottom of an inner wall of the body 10 and is configured to rotatably stir the waste liquids evenly, the body 10 also includes a circular tube 14 fixed on a top of the inner wall thereof, multiple spray heads 15 defined on the circular tube 14 and configured to molecularize the waste liquids, multiple heaters 16 arranged on the outer wall of the body 10 away from the motor M and configured to heat the water liquids in the body 10, and a discharge orifice 17 defined on a center of a bottom of the inner wall of the body 10 and configured to discharge toxic solvents or cleaning fluids of the waste liquids.

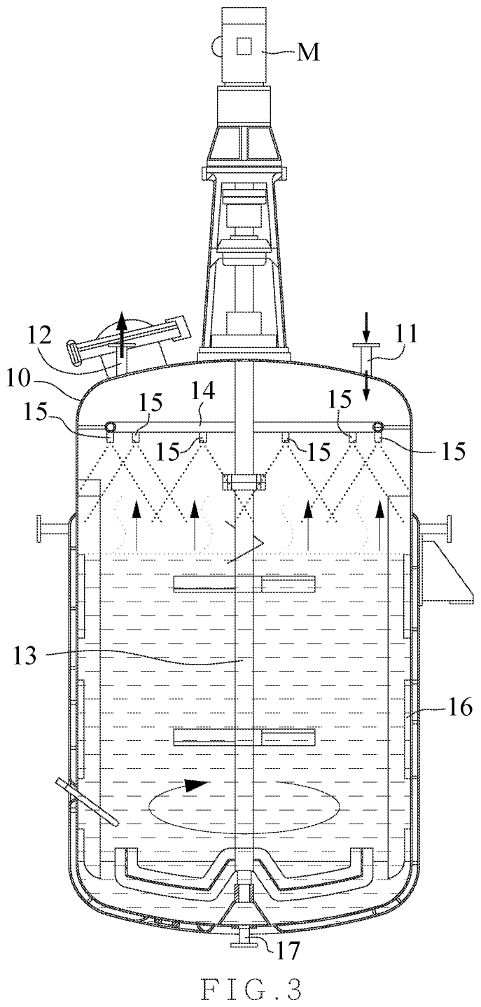

FIG. 3 is a cross sectional view showing the operation of the wastewater storage bucket capable of accelerately recycling waste liquids according to the preferred embodiment of the present invention. In operation, the motor M drives the stirrer 13 to rotatably stir the waste liquids evenly, thus separating the toxic solvents of the waste liquids from water. In the meantime, the multiple heaters 16 heat the water to steams. When the steams float upward, the multiple spray heads 15 of the circular tube 14 spray mists to condense the steams into the liquids, thus recycling the liquids. Thereafter, the liquids are purified to be recycled.

When introducing elements of the present invention or the preferred embodiments thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A wastewater storage bucket comprising a body, and the body including:
an outlet defined on a top of an outer wall of the body, an inlet formed on the top of the outer wall of the body opposite to the outlet, and a motor fixed on a center of the top of the outer wall of the body and configured to drive a stirrer to rotate, wherein the stirrer is vertically inserted into a bottom of an inner wall of the body and is configured to rotatably stir the waste liquids evenly;
wherein the body also includes a circular tube fixed on a top of the inner wall thereof, multiple spray heads defined on the circular tube and configured to molecularize the waste liquids, multiple heaters arranged on the outer wall of the body away from the motor and configured to heat the water liquids in the body, and a discharge orifice defined on a center of a bottom of the inner wall of the body and configured to discharge the waste liquids.
